(19) United States
(12) Patent Application Publication
(10) Pub. No.: US 2016/0196397 A1
(43) Pub. Date: Jul. 7, 2016

(54) SYSTEM AND METHOD FOR ACTIVE AND GROUP SHARING OF MEDICAL AND CASUALTY EXPENSES

(71) Applicant: Meir Avganim, Gealya (IL)

(72) Inventor: Meir Avganim, Gealya (IL)

(21) Appl. No.: 14/988,172

(22) Filed: Jan. 5, 2016

Related U.S. Application Data
(60) Provisional application No. 62/100,724, filed on Jan. 7, 2015.

(51) Int. Cl. G06F 19/00; G06Q 20/10; G07C 13/00; G06Q 40/08

(52) U.S. Cl. CPC G06F 19/328; G06Q 40/08; G06Q 20/102; G07C 13/00

(57) ABSTRACT

A payment system for active management and payment of group expenses incurred for services or casualty losses by a group comprising a plurality of end users. The system includes a main server with databases and operational modules; a plurality of remote user stations located remotely to the main server and associated with the plurality of end users of the payment system; a communication interface operatively connecting the remote user stations to the main server for providing operational controls by the end users over the payment system. The operational modules include: a customer interface module; an expense calculator module, configured to calculate members expenses incurred during a prior calculation period; a next period premium calculator module configured to calculate a next payment for said end users, a next premium notification module; and an automatic payment withdrawal module configured to automatically withdraw the next payment from accounts of the end users.

### CROSS-REFERENCE TO RELATED APPLICATION

This application claims benefit of and priority to U.S. Provisional Application Ser. No. 62/100,724 filed Jan. 7, 2015, the contents of which are incorporated herein by reference.

### BACKGROUND OF THE INVENTION

The present invention is directed to a system and method for handling insurance-like claims and, more particularly, to a group self-insurance system and method that handles insurance-like claims cooperatively.

Insurance companies rank as the richest and most profitable companies in the United States marketplace. In healthcare, for example, the costs of medical insurance have increased enormously during the past few years, way out of proportion to the actual cost of medical care delivery. The United States is unique among the world's nations in having this very profitable, private and profit driven insurance industry wedged between the healthcare consumers and the medical service providers. The current situation is such that many are blocked from accessing medical providers, owing to the cost alone. These concerns are also applicable to other forms of insurance, including insurance for automobiles, motorbikes and other insurance fields.

### SUMMARY OF THE INVENTION

One object of the present invention is to provide a system and method that reduces the cost of insurance without compromising on the delivery of medical services.

Another object of the present invention is to provide a system and method that has as its single and overriding aim, the reduction of the cost of insurance across the board, relative to all familiar aspects of life that are handled by insurance companies.

The foregoing and other objects of the invention are realized by a system and method which can be described as a crowd sourcing establishment where those who are part of the organization have their insurance needs met by an operation that covers all the expenses by its members by the pool of the members themselves. Thus, no payments for insurance are required. Rather, when a claim is made, all participants pay their share of the costs of the particular claim. Another option is to pay some money up front in order to capitalize the system to cover small claims and share with the group or pool of members their claims when they arise, with the possibility of either profit or leftover monies being returned to the members.

In specific forms thereof, the invention preferably comprises a payment system for active management and payment of group expenses incurred for services or casualty losses by a group comprising a plurality of end users, the payment system comprising: a main server comprising a plurality of databases and a plurality of operational modules; a plurality of remote user stations located remotely to the main server and associated with the plurality of end users of the payment system; a communication interface operatively connecting the remote user stations to the main server for providing operational controls by the end users over the payment system; and wherein the operational modules include: a customer interface module; an expense calculator module, configured to calculate members expenses incurred during a prior calculation period; a next period premium calculator module configured to calculate a next payment for said end users, based on and related to results obtained by the expense calculator module; a next premium notification module configured to send notifications to the end users of next payments to be made by the end users; and an automatic payment withdrawal module configured to automatically withdraw the next payment from an account of at least one of said end users.

Preferably, the operational modules further include: a voting topic proposal module configured to enable an end user to initiate a proposal for the end users to vote on; and an end user voting module configured to enable the end users to cast votes via their respective remote user stations. The payment system may include a management threshold module that is configured to enable end users to set at least one threshold participation parameters that are configured to alert end users to voting activities only when said parameters are met. The parameters include a voter percentage participation parameter, a monthly payment-increase parameter and/or both.

The plurality of operation modules may include a module configured to allow said end users to rate medical doctors and an operational module for setting a maximum month to month payment increase, beyond which payments for extra high expenses incurred by the end users are relegated to be financed by a separate financial institution. Also included may be an investment module holding invested capital of the end users, said investment module being associated with said accounts of said end users.

Also included may be a payment type parameter which is configured to enable separating the payment system to different types of payments relating to at least two of the following: medical payments for individuals, medical payments for legal entity employees, home owner expenses, automobile coverage payments and casualty losses payments. Also included may be a module configured to allow removal from end user membership of individuals who incur expenses greater than a predetermined amount over a predetermined time period. Also included may be a database of current top management workforce of the system and their compensations. Also included may be a member payment allocation module configured to set monthly payment participation percentages for members based on end user expense generation. Also included may be an expense account of individual end users that is listed and accessible to all end users, but identifies end users only through anonymous listing without actual identification of the persons or entities related to each expense account.

Also included may be a module for setting expense deductibles that are not payable by the payment system, wherein said deductibles are settable based on one or more of deductibles based on each event producing a claim for reimbursement and deductibles based on a predetermined time period. Also included may be a conventional insurance module for coverage of expenses incurred by said end users over a time period that exceeds a predetermined time duration.

Other features and advantages of the present invention will become apparent from the following description of the invention which refers to the accompanying drawings.

### BRIEF DESCRIPTION OF THE DRAWINGS

FIG. 1 is a block diagram of the main function and constituents of the invention.

FIG. 2 is a block diagram of certain algorithms and software-implemented functions of the invention.

FIG. 3 is a block diagram of further algorithms and software-implemented functions of the invention.

FIG. 4 is a block diagram of a management dashboard functionality of the present invention.

### DETAILED DESCRIPTION OF EMBODIMENTS OF THE INVENTION

It is important to appreciate at the start that the key feature of the invention is that enrollees, i.e., members of the system of the invention which is intended to handle claims, such as automobile coverage claims, medical claims or the like, do not pay insurance premiums, as such. Rather, the members pay out claims when they are made, based on pre-defined criteria. Alternatively, members pay a smaller, up front premium on a regular basis, in order to provide basic capitalization to run the system of the present invention with additional payments being calculated and made when claims arise.

Thereby, the claims handling system of the present invention is not run like an insurance company, but rather like a cost sharing co-op. For example, if the system has 10,000 enrollees or end users, i.e., members, and during a particular month a million dollars in claims have been approved for payment, then each member would pay $100 for that month. If, on a subsequent month, the claims approved for payment amount to two million dollars, then the monthly fee would be $200, in accordance with one operation made of the invention.

In accordance with the invention, members can be individually rated or scored by the other members. For example, members who have generated a history of more frequent 01846883.0 claims, would have a slightly higher membership assessment portion of the claim payments allocated to them.

The same system of membership can be used to handle different types of insurance claims, for example, auto insurance is one system; healthcare another system; life insurance a third; etc.

An optional aspect of the invention is that all claims and payments are public, except that the claimants and the premium payers are identified anonymously by code. Nonetheless, the system enables the members to search the database to identify which claimant (identified by number/code only) is the highest user of the coverage over a particular period, the types of coverages and their aggregate costs, etc.

The system of the invention is run by managers based on a reimbursement plan with various rules, regulations and bylaws stored in a database. The members can post a proposal for changes of the bylaws and the other members can comment on each proposal with a “like” vote or, for that matter, a “do not like” vote on the proposal. As a further example, if a particular proposal achieves a 10% “like” vote, the managers are obliged to post that preliminary proposal to all of the members, for example, by e-mail, for a further vote. If that second vote achieves a 35% “like” vote of the entire membership, then an actual vote is taken and the measure or bylaw or proposal will be adopted on a vote of 50% of the entire membership. Still, the management, which is much more knowledgeable on the insurance, can veto and reject the proposal on a two-thirds vote of the management members who are normally elected by the association, i.e., the co-operative members. In doing so, they must publish to the membership, a full statement and account why such a proposal passed by a majority of the members is actually harmful to the members.

Typically, the insurance association can be launched with various group plans initially obtained by purchasing coverage from conventional insurance companies. However, once the group attains a certain membership size, for example, 25,000 members, it can switch over to the private organization, where the members pay the expenses as they are incurred.

Examples of regulations or bylaws that can be passed by the members to keep the costs of insurance as low as possible include a litigation limits provision, for example, where each member agrees that if he/she has a litigation claim against a medical provider, for example, a physician, such a claim would only be permitted to be resolved only before a medical expert arbitration panel. This would allow a large medical provider to be willing to provide services to the association members at reduced rates, knowing that their cost of litigation would not be subject to the whims, capriciousness and unpredictability of juries and the legal establishment generally.

The association can contract to sign up at once large groups of people. For example, a corporation that has 1,000 employees can sign them up with the inventive association, perhaps at a slightly smaller per member charge. But eventually, the overall membership might propose/vote to charge the corporate group members the going rate or vote to rate each corporate member as being a non-corporate member.

To attain lower costs, comparatively larger deductibles can be mandatorily applied, unless an individual member opts not to have a deductible and his/her payments shall be considerably higher as compared to other members.

Consistent with the overall objective of keeping the cost as low as possible, payments of the claims by the membership should be by a pre-approved debit or credit card, whereby the billed amount is automatically withdrawn. Members might be dis-enrolled for non-payment or non-timely payments.

The system bylaws may provide that if, for a three year consecutive period, claim payments for a member exceed twice the average premium amount, in each year of the three year period, the payment portion may be doubled for the next two years, namely for years four and five.

It is not strictly necessary for the system of the present invention to actually own and operate a claim processing center, as this infrastructure and service can be sub-contracted to others, for example, an insurance company. Owing to the large groups, medical providers can be asked to allow three month or larger period to be paid on claims, which provides extra time for collecting the payments from the members, so that the system stays current and debt-free.

Another bylaw or rule of the system of the present invention may categorize members over a rolling three year periods as being heavy, intermediate or low claim submitters and their payments ranked accordingly, according to a ratio of, say, 1.5; 1.25; and 1, whereby heavy users would pay a larger proportionate amount of the overall costs.

In general, claims that have been approved for a next month payment cycle are used to calculate the members' next month's payments and immediate notices are sent to members in order to provide them a “heads up” notification regarding their next month's payments. Thereby, members can assure that their bank accounts from which payment will be drawn have sufficient funds to make the next month's payments. Nonetheless, given that particular months can be extremely heavy claim payment months, the system of the invention also has a credit line facility from which funds can be drawn to pay the heavy month claims, so that premium payments do not fluctuate wildly and members can pay out claims made over several time periods.

In general, the system of the invention provides that all claims made and premiums paid are available for the members to review, except that the identity of the claimants is maintained confidential, as well as the amount that each member must pay, except by identification through general geographical location and confidential ID numbers.

The system of the invention provides a database for each of all the various medical procedures as necessary, so that members can consult and know in advance what the approved amount for various procedures would be, which is of utmost importance to medical providers and users.

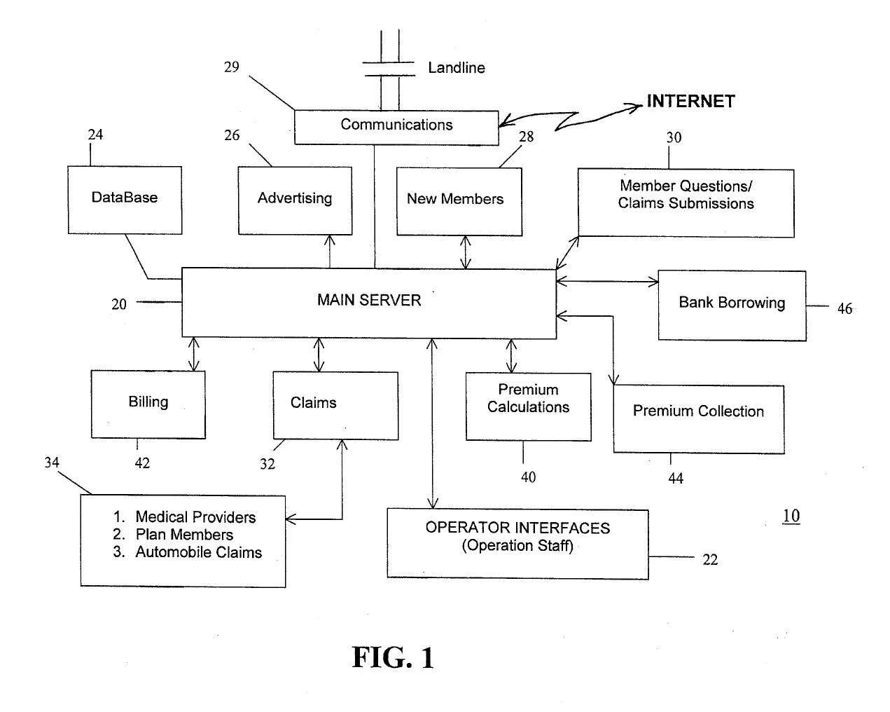

Referring to the drawings, FIG. 1 shows the system 10 of the invention comprising substantially a main server 20 which has all the usual computer/server hardware, including internal memory, CPUs, cache, permanent and volatile memory and all manners of communication device and interfaces 29, that are well known in the field of computers. The main server 20 runs various software modules and software facilities, including a database 24 in which are stored all the claim member personal information, medical doctor data, and like information. An advertising module 26 contains various promotional materials and information for the public at large that explains the operation of the system and invites the public to join the system of the invention.

Module 28 allows new members to sign on and takes them through an intake procedure that provides for such communication. The aforementioned communications hardware 29 provides an ability to communicate through landlines, such as a telephone and trunk lines, as well as via the Internet, wirelessly and the like.

Enrolled members can submit inquiries or check on claims or payment brackets through the module 30 which is configured for that purpose. The main server 20 is managed through operator interfaces 22 that allow an operation staff to set the various bylaws and to publish information to members and to otherwise maintain the software in a current state.

In normal operation, the members of the system of the invention submit claims through a claims module 32 which operates together with a claims interface 34 which communicates with and allows submission of claims by medical providers or allows information to be consulted by plan members or, for example, in a case of an automobile, automobile owners, and the like. Once claims are approved for the next payment period, the system activates the premium calculation module 40 to divide the cost of the payments for the claims and to calculate the proportionate share each member needs to pay for the coming pay period. This is then communicated by email or otherwise to the members through the billing module 42.

The next step of the system is to activate payment collection via the premium collection module 44, so that the overall cost of management is quite low, because very little human intervention is involved. In effect, collection fees owed is fully automated. In addition, the bank borrowing module 46 is instrumental in assuring that the premiums do not fluctuate wildly and that a credit facility is available to defray possibly extraordinary costs of the next month expenses if they are unusually large and to collect those funds over several months from the members and thereafter repay the credit facility.

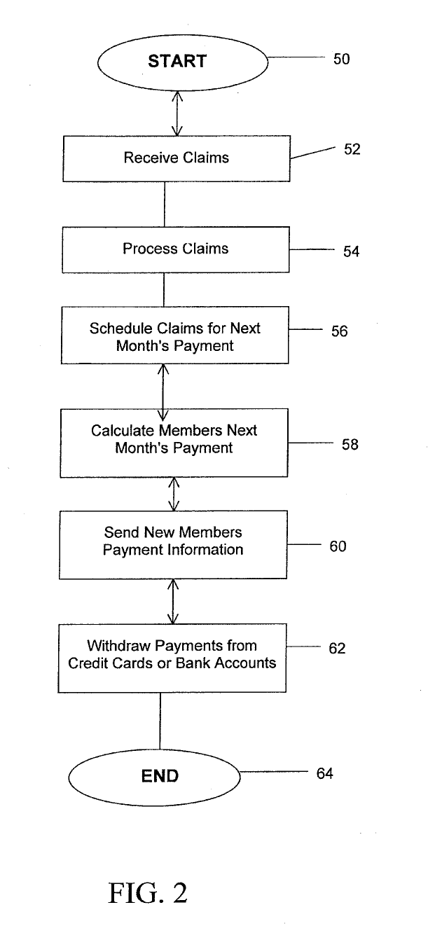

Referring to FIG. 2, a typical software flow is provided for certain of the functions of the system, including the software having a start module 50 for various initializations and housekeeping functions. When claims are received at step 52, they are processed at the claim processing software 54 and are scheduled for payment at step 56. Thereafter, the calculated premiums necessary for those payments are calculated at module 58 and the payment notices are sent with the payment due information at module 60. The process is concluded when the premiums are automatically collected at step 62 and this software module is concluded at step 64.

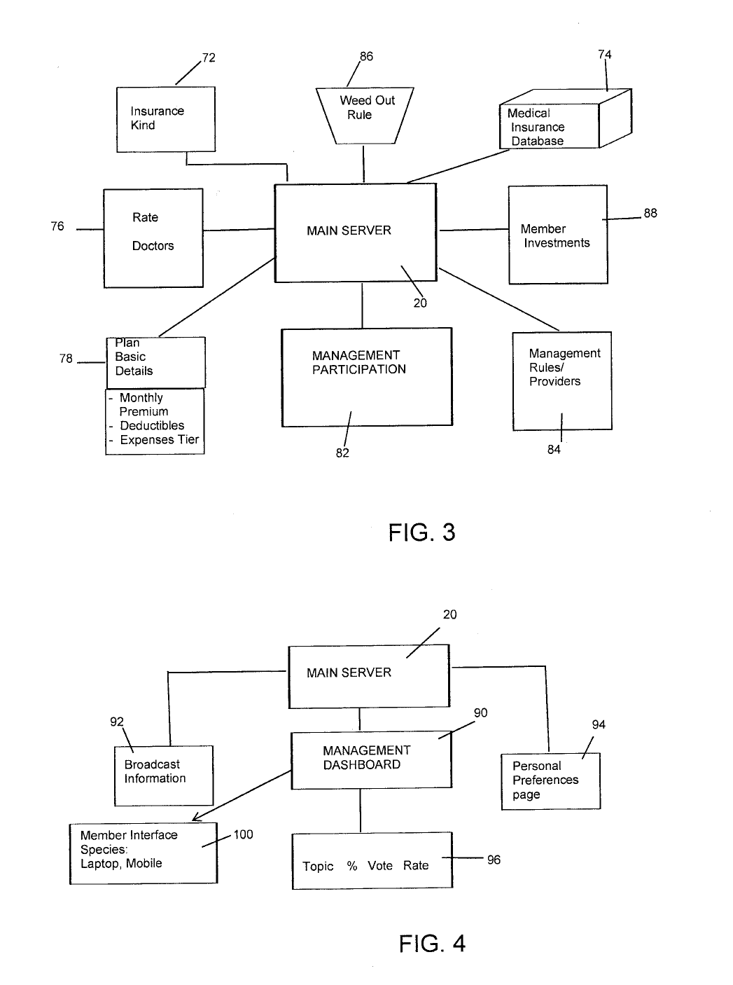

Referring to FIG. 3, the functional elements of the present invention may incorporate further developed features, including various modules to effect functionalities as described above and below. Thus, Module 72 is an “insurance kind” module which members can access in order to guide them to different types of products that are made available. For example, one product type may be strictly for medical insurance for individuals. Another product may be medical insurance provided to and purchased by business entities for their employees. Another insurance type may relate to automobiles. Another insurance type may relate to casualty insurance and so on. Each insurance kind refers to an entirely different product that has different membership rules and different modes of participation in the system and method for active and group sharing of expenses in accordance with the concept of the invention.

Module 74 is a medical expense database and comprises a list of all possible medical procedures and the rates of reimbursement that the group would pay to medical providers. Module 76 allows members to rate medical doctors based on their personal experiences with the medical doctors and this information is accessible to all of the members of the system of the invention. Module 88 is a members' investment module that functions similar to a bank/brokerage firm and which allows members to invest funds in either fixed assets or equities and the like. The main point and objective of the member investor's module is that each member must always maintain a balance that is sufficient to cover, for example, one or several months of expected expenses of the overall system. The investor's module permits members to invest jointly and earn higher returns than possible by individuals, while simultaneously providing to the system a payment source from which the monthly/quarterly pseudo-premiums owed by each member can be drawn.

Module 78 is a database that provides the plan basic details, including current monthly premiums, deductibles and member plans, various expense tiers of different members and so on. In connection with the expense tier functionality, the inventor contemplates that members (who will always be identified by a code only, without identifying actual people) might be grouped into classes, for example, members that have a yearly expense average that is below that of another group, allowing the setting of payments that rank those payments based, to a degree on usage, i.e., the higher the usage, the greater the pseudo-premium payments.

Module 82 is the management component that enables all of the members to participate in various management decisions down to even very small levels, as more fully described below.

Module 84 is a database containing the management rules and the various procedures, algorithms, functionalities and methodologies for enabling the membership to participate in the overall management of the business.

Module 86 enables the membership to set rules for weeding out members whose expense generation does not meet with the overall objectives of the membership group. For example, members that generate extraordinary expenses over a given period, may be issued notices, for example, a twelve month notice that they must seek other channels or forms of insurance or be relegated to a special group populated by other higher expenses members with very high premium payments. In general, the purpose of the invention is for members to share and pay for expenses as they occur. To this end, members may be required to purchase bona fide insurance policies that cover expenses within each year that exceed, say, 100,000 dollars.

Turning to FIG. 4, the emphasis in this figure is on the management component of the invention which is a key aspect of the invention. Thus, main server 20 interfaces with a management dashboard to which individual members have access through module 100 via their desktop computers or laptops, or mobile devices such as mobile phones and the like. For the management functionality, the personal preferences module 94 allows individual members to set preferences that indicate to the management dashboard, the level of management details that a particular member wants to be involved with. For example, a member may set up a preference not to receive notices regarding management decisions involving the investing component of the system.

The module 92 is a broadcast module that broadcasts alerts to members, for example, that votes on given issues or topics are to take place, and times therefor.

Module 96 is particularly important. For example, it will show a list of the topics that are coming up for a vote, the percentage participation in the vote at the time of broadcast and the final vote date, after which the decision on a particular issue will be made. This last feature is particularly important for the reason that it is, in fact, the module that sets a novel way of group participation in relation to management decisions.

For example, suppose that a decision is required as to whether to raise the maximum monthly premium that members should pay for medical insurance. Such a proposal can be first proposed by a member using the interface 100 module, presented as a proposal for decision. Such a proposal would be broadcast to only those members who indicate that they want to receive such proposals right at the outset. Many other members, might say that they do not want to receive such proposals before at least ten percent of the membership has already indicated they are interested in bringing it up for a vote. Other members might set a threshold at 30%. Regardless, different proposals concerning different subjects might require a minimum participation before it would be put up for a vote. Some members might state that they do not wish to see any proposals for a vote until a final day for the vote on that proposal is set. However, the membership rules might be such that certain issues will be automatically tabled, i.e., die, “in committee”, because they never reach a minimum vote needed to proceed on them which might be set, for example, to 35% participation. Certain proposals might require the actual vote to be 40%. The percentages for both participation and for enacting provisions might be set in the basic rule plan, as part of what members vote on.

In effect, members can opt to participate in initiating decisions, involving a review of the business scenario of the whole cost sharing enterprise, and then make proposals and if enough members vote to move forward with the proposal, such a proposal would come to a vote. Naturally, the management of the company will run day-to-day affairs of the membership. However, the system allows the membership to touch on even minor issues, including, for example, the compensation that is paid to the top and middle management of the enterprise. A membership might raise issues about what the minimum deductibles should be per year. The membership might also determine what the co-pay amounts would be for the members.

It should be appreciated that in the present invention, myriads of additional details are provided such as those relating to discounts, adjustments and other on-going activities that would be adapted and adopted to the growing needs of the system members.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A payment system for active management and payment of group expenses incurred for services or casualty losses by a group comprising a plurality of end users, the payment system comprising:
a main server comprising a plurality of databases and a plurality of operational modules;
a plurality of remote user stations located remotely to the main server and associated with the plurality of end users of the payment system;
a communication interface operatively connecting the remote user stations to the main server for providing operational controls by the end users over the payment system; and
wherein the operational modules include:
a. a customer interface module;
b. an expense calculator module, configured to calculate members expenses incurred during a prior calculation period;
c. a next period premium calculator module configured to calculate a next payment for said end users, based on and related to results obtained by the expense calculator module;
d. a next premium notification module configured to send notifications to the end users of next payments to be made by the end users; and
e. an automatic payment withdrawal module configured to automatically withdraw the next payment from an account of at least one of said end users.

2. The payment system of claim 1, wherein the operational modules further include:
f. a voting topic proposal module configured to enable an end user to initiate a proposal for the end users to vote on; and
g. an end user voting module configured to enable the end users to cast votes via their respective remote user stations.

3. The payment system of claim 2, including a management threshold module that is configured to enable end users to set at least one threshold participation parameters that are configured to alert end users to voting activities only when said parameters are met.

4. The payment system of claim 3, wherein said parameters include a voter percentage participation parameter.

5. The payment system of claim 3, wherein said parameters include a monthly payment-increase parameter.

6. The payment system of claim 3, wherein said parameters include a voter participation parameter and a monthly payment-increase parameter.

7. The payment system of claim 1, wherein said plurality of operation modules include a module configured to allow said end users to rate medical doctors.

8. The payment system of claim 1, including an operational module for setting a maximum month to month payment increase, beyond which payments for extra high expenses incurred by the end users are relegated to be financed by a separate financial institution.

9. The payment system of claim 1, further including an investment module holding invested capital of the end users, said investment module being associated with said accounts of said end users.

10. The payment system of claim 1, further including a payment type parameter which is configured to enable separating the payment system to different types of payments relating to at least two of the following: medical payments for individuals, medical payments for legal entity employees, home owner expenses, automobile coverage payments and casualty losses payments.

11. The payment system of claim 1, further including a module configured to allow removal from end user membership of individuals who incur expenses greater than a predetermined amount over a predetermined time period.

12. The payment system of claim 1, further including a database of current top management workforce of the system and their compensations.

13. The payment system of claim 1, further including a member payment allocation module configured to set monthly payment participation percentages for members based on end user expense generation.

14. The payment system of claim 1, further including an expense account of individual end users that is listed and accessible to all end users, but identifies end users only through anonymous listing without actual identification of the persons or entities related to each expense account.

15. The payment system of claim 1, further including a module for setting expense deductibles that are not payable by the payment system.

16. The payment system of claim 15, wherein said deductibles are settable based on one or more of deductibles based on each event producing a claim for reimbursement and deductibles based on a predetermined time period.

17. The payment system of claim 1, further including a conventional insurance module for coverage of expenses incurred by said end users over a time period that exceeds a predetermined time duration.
